(19) United States
(12) Patent Application Publication
(10) Pub. No.: US 2003/0183906 A1
(43) Pub. Date: Oct. 2, 2003

(54) Grounding cable and semiconductor manufacturing apparatus using the same

(76) Inventor: Gi-Chung Kwon, Gwangjoo-gun (KR)

Correspondence Address: BAKER & DANIELS, 300 NORTH MERIDIAN STREET, SUITE 2700, INDIANAPOLIS, IN, 46204-1782, US

(21) Appl. No.: 10/397,629

(22) Filed: Mar. 26, 2003

(30) Foreign Application Priority Data
Mar. 27, 2002 (KR) 2002-16851

(51) Int. Cl. H02G 15/02

(52) U.S. Cl. 257/664

(57) ABSTRACT

A grounding cable includes a first grounding wire, a first outer cover surrounding the first grounding wire and made of an insulating material, a second grounding wire enclosing the first outer cover, and a second outer cover surrounding the second grounding wire.

This application claims the benefit of Korean Patent Application No. 2002-16851, filed on Mar. 27, 2002 in Korea, which is hereby incorporated by reference for all purposes as if fully set forth herein.

### BACKGROUND OF THE INVENTION

1. Field of the Invention

The present invention relates to an apparatus for manufacturing semiconductor devices, and more particularly, to a grounding cable and a semiconductor manufacturing apparatus using the same.

2. Discussion of the Related Art

Semiconductor devices, which are large scale integration (LSI) circuits, are mostly manufactured in a chamber that is an airtight reaction ;container by repeating processes of depositing a thin film on a silicon wafer substrate and patterning the thin film.

In manufacturing the semiconductor devices, there have been efforts to enlarge the size of the silicon wafer substrate and to improve the quality of the semiconductor devices and the manufacturing productivity by forming fine patterns. Consequently, a manufacturing method using plasma has been developed, and enables ultra large scale integration (ULSI) circuits to be formed.

FIG. 1 shows schematically an apparatus for manufacturing a semiconductor device using plasma according to the related art. The apparatus includes a reaction chamber, a plasma generating source and other electric devices.

In FIG. 1, the chamber 20 is a reaction container to define an airtight reaction region 21 therein, and in the chamber 20, a thin film may be deposit on a substrate 1, which is a silicon wafer and is situated in the reaction region 21, or a thin film on the substrate 1 may be patterned through chemical reactions of gases injected into the chamber 20. The chamber 20 includes a gas inlet 22 and an outlet 24. The gas inlet 22 is a path of reaction gases, and the reaction gases are supplied into the chamber 20 through the gas inlet 22. The air within the chamber 20 is exhausted through the outlet 24. In the chamber 20, a wafer chuck 30, which may be a susceptor, is disposed to support the substrate 1.

A plasma generating source 40 and other electric devices (not shown) are attached to the chamber 20, and plasma is generated in the reaction region 21, so that the substrate 1 is treated. To do this, an upper portion 20a of the chamber 20 is usually made of an insulating material such as quartz and a first electrode 42 is located on the upper portion 20a of the chamber 20. The first electrode 42 may have a spiral shape, for example. Radio frequency (RF) power of high frequency is applied to the first electrode 42 from a first power supplier 46, and a first impedance matching device 44 is equipped between the first electrode 42 and the first power supplier 46 so as to match frequency of the RF power. The first electrode 42, the first impedance matching device 44 and the first power supplier 46 constitute the plasma generating source 40.

A bias source 50 is attached to the chamber 20 too. The bias source 50 controls impact energy of reaction materials in plasma generated by the plasma generating source 40. The bias source 50 comprises a second electrode 52, a second impedance matching device 54 and a second power supplier 56, and the second electrode 52 is commonly disposed in the chuck 30.

The substrate 1 is loaded on the chuck 30, and the chamber 20 is made airtight. The air in the chamber 20 is exhausted through the outlet 24 and the chamber 20 is under vacuum condition. The reaction gases are injected into the reaction region 21 of the chamber 10 through the gas inlet 22. At the same time, electric field is induced in the reaction region 21 by the plasma generating source 40, and the electric field varies with the lapse of time. Then, the reaction gases are transformed into plasma, which is composed of ions, electrons, and neutral particles, and the reaction materials in the plasma are accelerated by the bias source 50 to collide with the substrate 1. The plasma generating source 40 and the bias source 50 are controlled by an electronic control circuitry (not shown).

In the chamber 20, the substrate 1 is dealt with by collision with the reaction materials of the plasma. Here, first to fifth grounding terminals 62, 64, 66, 68 and 70 are connected to the first and second power suppliers 46 and 56, the first and second impedance matching devices 44 and 54, and the chamber 20, respectively, to make equipotential and to remove noises from the first and second power suppliers 46 and 56. The first to fifth grounding terminals 62, 64, 66, 68 and 70 are connected to respective grounding points with grounding cables.

FIG. 2 is a schematic circuit view of FIG. 1 to explain a grounding structure of a plasma chamber according to the related art. In FIG. 2, the first and second power suppliers 46 and 56, the first and second impedance matching devices 44 and 54, and the chamber 20 are connected to the first, second, third, fourth, and fifth grounding terminals 62, 64, 66, 68, and 70, respectively, and are grounded.

FIG. 3 shows a perspective view of a grounding cable according to the related art. In FIG. 3, the grounding cable 80a comprises a grounding wire 82a and an outer cover 84a. The grounding wire 82a is made of a metal material, which has high electrical conductivity, and has a columnar shape. The outer cover 84a has a tubular shape and surrounds the first grounding wire 82a. The grounding wire 82a is made of copper (Cu) or Cu coated with nickel (Ni), and the outer cover 84a is made of a high molecular substance such as polyvinyl chloride (PVC). Although the grounding cable 80a has a circular section, the grounding cable 80a may have various sections including a rectangular section, for example.

The grounding cable 80a of FIG. 3 does not control high frequency current effectively, and impedance increases due to high frequency current flowing on a wire surface to raise grounding potential and equipotential. Therefore, it is hard to accomplish manufacturing processes of the semiconductor device because output RF powers of the first and second power suppliers 46 and 56 of FIG. 2 rise and interference increases from RF noise between the first impedance matching device 44 of FIG. 2 and the second impedance matching device 54 of FIG. 2, between the chamber 20 of FIG. 2 and the first and second impedance matching devices 44 and 54 of FIG. 2, and between the first and second impedance matching devices 44 and 54 of FIG. 2 and the electronic control circuitry. Additionally, it is limited to control rising of the grounding potential and the equipotential owing to inductance of the grounding wire 82a, which goes up according to the increase of frequency.

To solve the above problem, another grounding cable, which has an enlarged surface area in consideration of the characteristics of the high frequency power, has been developed. FIG. 4 shows a perspective view of another grounding cable according to the related art. The grounding cable of FIG. 4 includes a grounding wire 82b that has a tubular mesh structure made of a plurality of fine metal lines. The grounding wire 82b is formed of copper (Cu) or an alloy of nickel (Ni) and tin (Sn).

An outer cover 84b encloses the first grounding wire 82b, and the outer cover 84b is made of a high molecular substance such as polyvinyl chloride (PVC). Here, an insulator 86b, which is made of the same material as the outer cover 84b, may be inserted in the grounding wire 82b. Although the grounding cable 80b has a rectangular section, the grounding cable 80b may have a circular section.

However, the second grounding cable 80b has several problems too. The grounding potential rises due to low frequency current, and thus in the whole system, the equipotential goes up. Additionally, it is hard to minimize the noise interference between the first and second impedance matching devices 44 and 54, the chamber 20 of FIG. 2 and the electronic control circuitry.

### SUMMARY OF THE INVENTION

Accordingly, the present invention is directed to a grounding cable and a semiconductor manufacturing apparatus using the same that substantially obviates one or more of problems due to limitations and disadvantages of the related art.

An advantage of the present invention is to provide a grounding cable and a semiconductor manufacturing apparatus using the same that minimize noise interferences in the apparatus and prevent grounding potential from increasing.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a grounding cable includes a first grounding wire, a first outer cover surrounding the first grounding wire and made of an insulating material, a second grounding wire enclosing the first outer cover, and a second outer cover surrounding the second grounding wire.

In another aspect, a semiconductor manufacturing apparatus using grounding cables includes a chamber, a plasma generating source including a first electrode in the chamber, a first power supplier and a first impedance matching device out of the chamber, a bias source including a second electrode in the chamber, a second power supplier and a second impedance matching device out of the chamber, and first, second, third, fourth and fifth grounding cables, each of the grounding cables connected to the first and second power suppliers, the first and second impedance matching devices and the chamber, respectively, each of the grounding cables including a first grounding wire, a first outer cover surrounding the first grounding wire and made of an insulating material, a second grounding wire enclosing the first outer cover, and a second outer cover surrounding the second grounding wire.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing schematically an apparatus for manufacturing semiconductor devices using plasma according to the related art;

FIG. 2 is a schematic circuit view of FIG. 1 to explain a grounding structure of a plasma chamber according to the related art;

FIG. 3 is a perspective view of a grounding cable according to the related art;

FIG. 4 is a perspective view of another grounding cable according to the related art;

FIG. 5 is a perspective view of a grounding cable according to an embodiment of the present invention; and

FIG. 6 is a schematic circuit view for a grounding structure of a semiconductor manufacturing apparatus using a grounding cable according to the present invention.

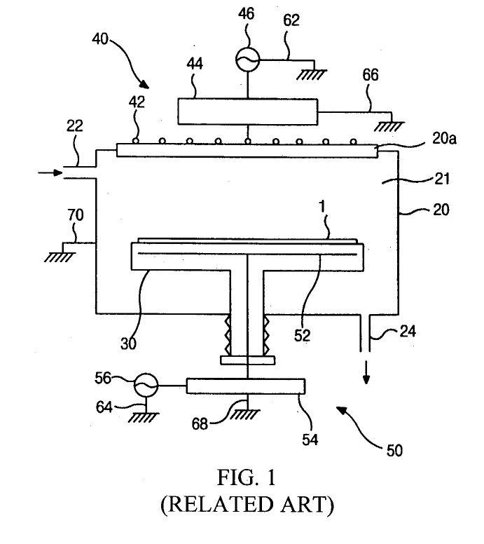

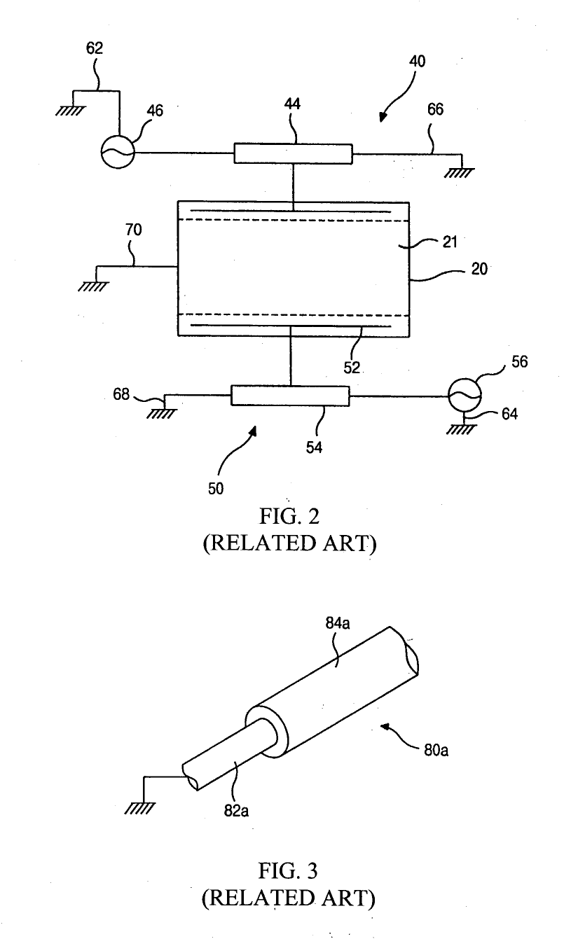

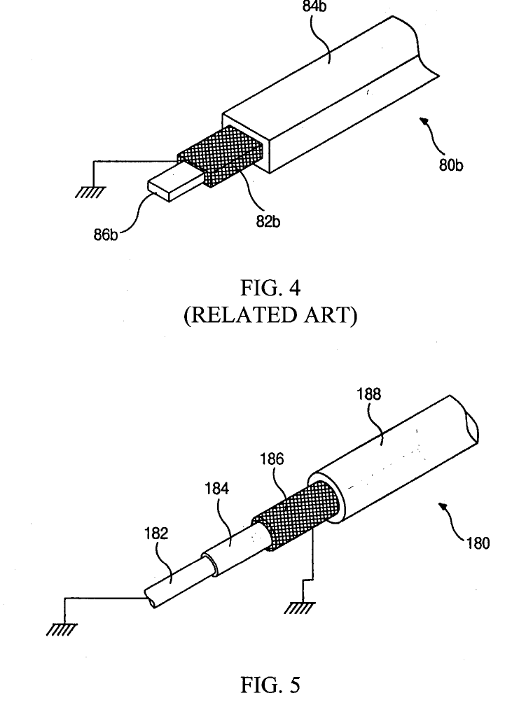

### DETAILED DESCRIPTION OF THE ILLUSTRATED EMBODIMENTS

Reference will now be made in detail to the illustrated embodiment of the present invention, the example of which is illustrated in the accompanying drawings.

FIG. 5 is a perspective view of a grounding cable according to an embodiment of the present invention.

In FIG. 5, the grounding cable 180 includes a first grounding wire 182, a first outer cover 184, a second grounding wire 186 and a second outer cover 188. The first grounding wire 182 is made of a metal material, and has a columnar shape. The first outer cover 184 is made of an insulating material having a tubular shape, and surrounds the first grounding wire 182. The second grounding wire 186 is made of a plurality of fine metal lines, and has a tubular mesh structure to enclose the first outer cover 184. The second outer cover 188 is made of an insulating material, and surrounds the second grounding wire 186. Though not shown in the figure, the grounding cable 180 may have a circular section, and sections of the first grounding wire 182, the first outer cover 184, the second grounding wire 186 and the second outer cover 188 are concentric circles. The first and second grounding wires 182 and 186 may include one of copper (Cu), Cu coated with nickel (Ni) and an alloy of the Cu and Ni. The first and second outer covers 184 and 188 may include a high molecular substance such as polyvinyl chloride (PVC).

In the grounding cable 180 of FIG. 5, the first and second grounding wires 182 and 186 connect grounding points to grounding terminals in parallel, respectively.

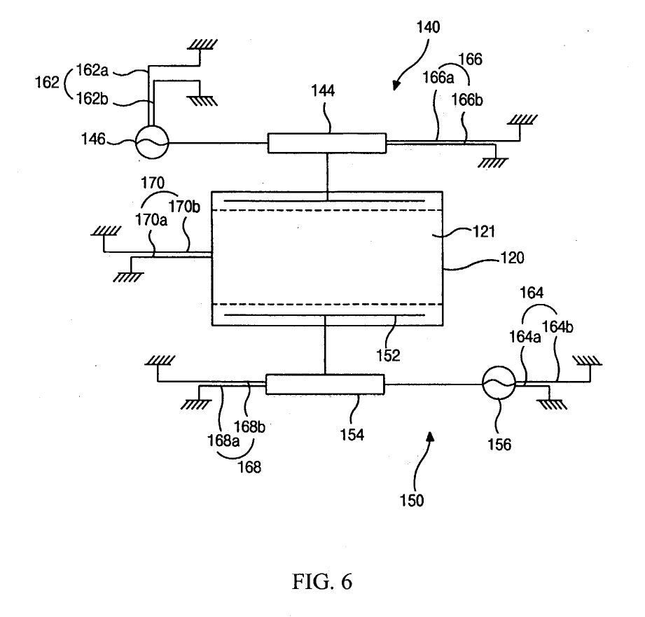

FIG. 6 shows a semiconductor manufacturing apparatus using the grounding cable of FIG. 5, and is a schematic circuit view for a grounding structure of the semiconductor manufacturing apparatus. In FIG. 6, the apparatus includes a chamber 120, a plasma generating source 140 and a bias source 150. The chamber 120 is a reaction container to define an airtight reaction region 121 therein, and in the reaction region 121, a substrate (not shown) is situated. Though not shown in the figure, the chamber 120 includes a gas inlet and an outlet as stated before. The gas inlet is a path of reaction gases, and the reaction gases are supplied into the chamber 120 through the gas inlet. The air within the chamber is exhausted through the outlet. In the chamber 120, a wafer chuck (not shown), which may be a susceptor, is disposed to support the substrate.

A plasma generating source 140 induces plasma in the reaction region 121, and includes a first electrode 142, a first impedance matching device 144 and a first power supplier 146. Radio frequency (RF) power of high frequency is applied to the first electrode 142 from the first power supplier 146, and the first impedance matching device 144 is equipped between the first electrode 142 and the first power supplier 146 so as to match frequency of the RF power.

The bias source 150 controls impact energy of reaction materials in plasma induced by the plasma generating source 140. The bias source 150 comprises a second electrode 152, a second impedance matching device 154 and a second power supplier 156. The second electrode 152 may be disposed in the wafer chuck (not shown). The plasma generating source 140 and the bias source 150 are controlled by an electronic control circuitry (not shown).

The apparatus of the present invention further includes first, second, third, fourth and fifth grounding terminals 162, 164, 166, 168 and 170 using the grounding cable 180 of FIG. 5 to make the first and second power suppliers 146 and 156, the first and second impedance matching device 144 and 154 and the chamber 120 equipotential and to remove RF noises. Each first portion of the grounding terminals 162a, 164a, 166a, 168a and 170a uses the first grounding wire 182 of FIG. 5 and each second portion of the grounding terminals 162b, 164b, 166b, 168b and 170b uses the second grounding wire 186 of FIG. 5.

Therefore, in the present invention, first ends of the first and second grounding wires 182 and 186 of the grounding terminals 162, 164, 166, 168 and 170 are connected to the first and second power suppliers 146 and 156, the first and second impedance matching devices 144 and 154, and the chamber 120, respectively. Second ends of the first and second grounding wires 182 and 186 of the grounding terminals 162, 164, 166, 168 and 170 are grounded. Here, low frequency currents are grounded through the first grounding wires 182 of the grounding terminals and high frequency currents are grounded through the second grounding wires 186 of the grounding terminals. Therefore, noises from the low and high frequency currents are reduced due to the grounding cable of the present invention. Signals, which are caused by the noises and lead to wrong operating, can be decreased.

As stated above, the first grounding wires 182 of the grounding terminals are made of a metal material of a columnar shape, and the second grounding wires 186 of the grounding terminals have a mesh structure made of a plurality of fine metal lines.

Generally, currents in the center of a wire are cancelled out due to an eddy current induced by induced electromotive force and induced magnetic filed according to the increasing of frequency. Therefore, high frequency currents flow only on the surface of the wire. Here, a skin depth, which is a depth or distance that the currents can flow through or penetrate in the wire, is defined as

$$1 / \sqrt{\prod f μσ} ,$$

wherein σ is electric conductivity, f is an applied frequency, and μ is magnetic permeability of the wire. In a copper wire having a diameter of about 1 cm, if the applied frequency f is about 60 Hz, the electric conductivity σ is about 1.256×10⁻⁶ Ωcm and the skin depth δ is about 0.86 cm. If the applied frequency f is about 1 MHz, the skin depth δ is about 0.007 cm and if the applied frequency f is about 13.56 MHz, the skin depth δ is about 18 μm.

When 13.56 MHz frequency is applied, the current flows penetrating the copper wire by about 18 μm from a wire surface. For about 60 Hz frequency, the current flows uniformly extending over the whole copper wire.

Accordingly, in the present invention, a columnar metal material is used as the first grounding wire in order to ground low frequency currents less than 60 Hz. A mesh metal material having a large surface area is used as the second grounding wire so as to ground high frequency currents, thereby reducing noise voltage and impedance of current in a high frequency band. Therefore, in the present invention, noise interferences in the apparatus are minimized and grounding potential are prevented from increasing.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A grounding cable, comprising:
a first grounding wire;
a first outer cover surrounding the first grounding wire and made of an insulating material;
a second grounding wire enclosing the first outer cover; and
a second outer cover surrounding the second grounding wire.

2. The grounding cable according to claim 1, wherein the second grounding wire has a mesh structure.

3. The grounding cable according to claim 1, wherein the first and second grounding wires is made of a metal material and the metal material includes one of copper, copper coated with nickel and an alloy of copper and nickel.

4. The grounding cable according to claim 1, wherein the first and second outer covers include polyvinyl chloride (PVC).

5. A semiconductor manufacturing apparatus using grounding cables, comprising:
a chamber;
a plasma generating source including a first electrode in the chamber, a first power supplier and a first impedance matching device out of the chamber;
a bias source including a second electrode in the chamber, a second power supplier and a second impedance matching device out of the chamber; and
first, second, third, fourth and fifth grounding cables, each of the grounding cables connected to the first and second power suppliers, the first and second impedance matching devices and the chamber, respectively, each of the grounding cables including:
a first grounding wire;
a first outer cover surrounding the first grounding wire and made of an insulating material;
a second grounding wire enclosing the first outer cover; and
a second outer cover surrounding the second grounding wire.

6. The apparatus according to claim 5, wherein the second grounding wire has a mesh structure.

7. The apparatus according to claim 5, wherein the first and second grounding wires include one of copper, copper coated with nickel and an alloy of copper and nickel.

8. The apparatus according to claim 5, wherein the first and second outer covers include polyvinyl chloride (PVC).
